(19) United States
(12) Patent Application Publication
(10) Pub. No.: US 2008/0276780 A1
(43) Pub. Date: Nov. 13, 2008

(54) COMBINING DEVICE FOR THE CHOPPER SET OF A TABLE SAWING MACHINE

(76) Inventor: Bor-Yann Chuang, Taiping City (TW)

Correspondence Address: SINORICA, LLC, 528 FALLSGROVE DRIVE, ROCKVILLE, MD, 20850, US

(21) Appl. No.: 11/747,255

(22) Filed: May 11, 2007

(51) Int. Cl. B23D 19/02

(52) U.S. Cl. 83/508

(57) ABSTRACT

A combining device for the chopper set of a table sawing machine includes at least a fixing base, a chopper plate and an eccentric shaft. The fixing base secured in a table sawing machine body has a vertical wall bored with a threaded hole and having its opposite sides respectively provided with a position-limiting recess. The eccentric shaft has its front side screwed in the threaded hole of the fixing base, disposed with an eccentric press member. The chopper plate has its lower end formed with a positioning member fitted in the position-limiting recesses, cut with a long notch at a location matching with the threaded hole. When the eccentric shaft is rotated, the press member presses one sidewall of the long notch to firmly fix the chopper plate in the position-limiting recesses of the fixing base.

### BACKGROUND OF THE INVENTION

1. Field of the Invention

This invention relates to a combining device for the chopper set of a table sawing machine, particularly to one provided with an eccentric shaft to be rotated forward to press a chopper plate and firmly fix the chopper plate in the opposite position-limiting recesses of a fixing base, able to assemble and disassemble the chopper set easily and quickly.

2. Description of the Prior Art

A conventional combining device for the chopper set of a table saw disclosed in a US patent of No. 2005/0166736, titled “Table saws with safety systems and systems to mount and index attachment”, as shown in FIG. 1, is provided with a clamping device 20 under a chopper plate 10. The clamping device 20 is composed of a handle 21, a bolt 22, a clamping plate 23, a fixed base 24 and a spring 25. The handle 21 has the front end of its upper edge disposed with a cam surface 211, and the fixed base 24 is formed with a clamping surface 241 facing the clamping plate 23. The bolt 22 is screwed in both the clamping plate 23 and the fixed base 24, and the spring 25 is fitted around the bolt 22 and positioned between the clamping plate 23 and the fixed base 24. When the handle 21 is pulled, the cam surface 211 will push the clamping plate 23 to move forward to adjust its relative position to the clamping surface 241 of the fixed base 24 for tightly clamping the chopper plate 10 positioned between the clamping plate 23 and the clamping surface 241. Further, the spring 25 can function to release or push the clamping plate 23. Thus, the chopper plate 10 can be tightly clamped between the clamping plate 23 and the clamping surface 241 of the fixed base 24 by means of the clamping device 20.

However, although the conventional chopper plate 10 can be firmly fixed between the clamping plate 23 and the fixed base 24 by pulling the handle 21, the bolt 22 has to be fitted in the spring 25 in advance, complicated in the components and inconvenient in assembly. In addition, the handle 21 is complicated in structure and its operating distance is long so that it is likely to interfere the inner components of a table saw, thus causing inconvenience in operation and increasing processing cost.

### SUMMARY OF THE INVENTION

The objective of this invention is to offer a combining device for the chopper set of a table sawing machine, including a fixing base, an eccentric shaft and a chopper plate. The fixing base to base cured in the body of a table sawing machine is formed with a vertical sidewall bored with a threaded hole and having its opposite sides respectively provided with a vertical position-limiting recess. The eccentric shaft has its front side pivotally screwed in the threaded hole of the fixing base, axially provided with an annular eccentric press member. The chopper plate has its lower end formed with a positioning member to be slidably fitted in the two position-limiting recesses of the fixing base, cut with a vertical long notch at a location matching with the threaded hole of the fixing base. The eccentric shaft further has its rear side disposed with a turning member to be turned for actuating the eccentric shaft to rotate and have its press member push one sidewall of the vertical long notch of the chopper plate for fixing the chopper plate in the position-limiting recesses of the fixing base. By so designing, the chopper plate can quickly and easily be assembled on or disassembled from the fixing base by directly turning the turning member of the eccentric shaft, unnecessary to use any tool, greatly elevating efficiency and saving time in assembling and disassembling of the chopper plate.

### BRIEF DESCRIPTION OF DRAWINGS

This invention will be better understood by referring to the accompanying drawings, wherein:

FIG. 1 is a cross-sectional view of the clamping device of a conventional table saw;

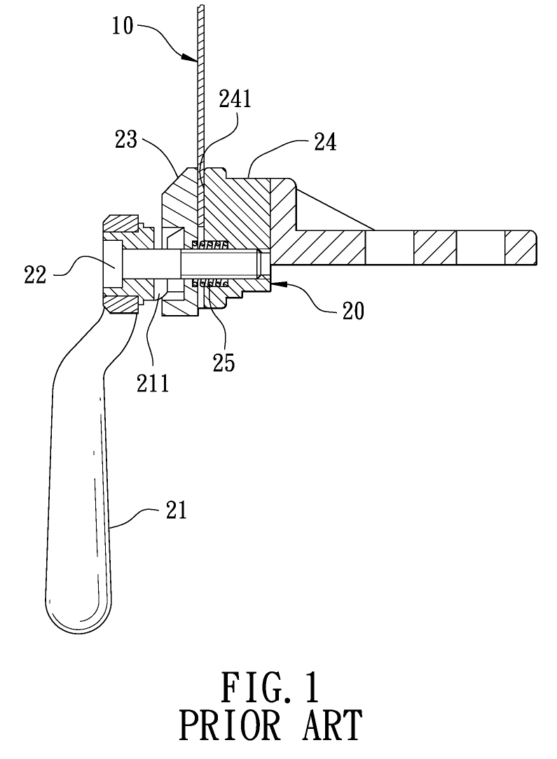

FIG. 2 is a perspective view of a first preferred embodiment of a combining device for the chopper set of a table sawing machine in the present invention;

FIG. 3 is a partial exploded perspective view of the first preferred embodiment of the combining device for the chopper set of a table sawing machine in the present invention;

FIG. 4 is a cross-sectional view of the first preferred embodiment of the combining device for the chopper set of a table sawing machine in the present invention;

FIG. 5 is a side cross-sectional view of the first preferred embodiment of the combining device for the chopper set of a table sawing machine in the present invention;

FIG. 6 is a cross-sectional view of the first preferred embodiment of the combining device for the chopper set of a table sawing machine in a disassembling condition in the present invention;

FIG. 7 is a front view of the first preferred embodiment of the combining device for the chopper set of a table sawing machine in the present invention, showing that a chopper plate is disassembled from a fixing base in the present invention; and

FIG. 8 is a partial perspective view of a second preferred embodiment of a combining device for the chopper set of a table sawing machine in the present invention.

### DETAILED DESCRIPTION OF THE PREFERRED EMBODIMENT

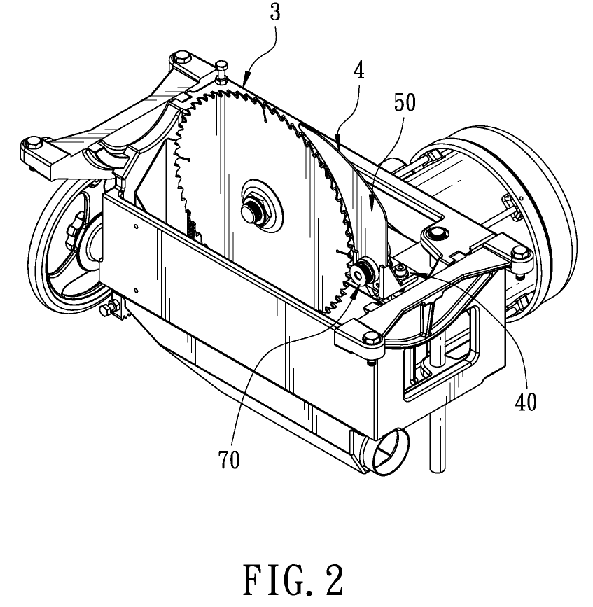

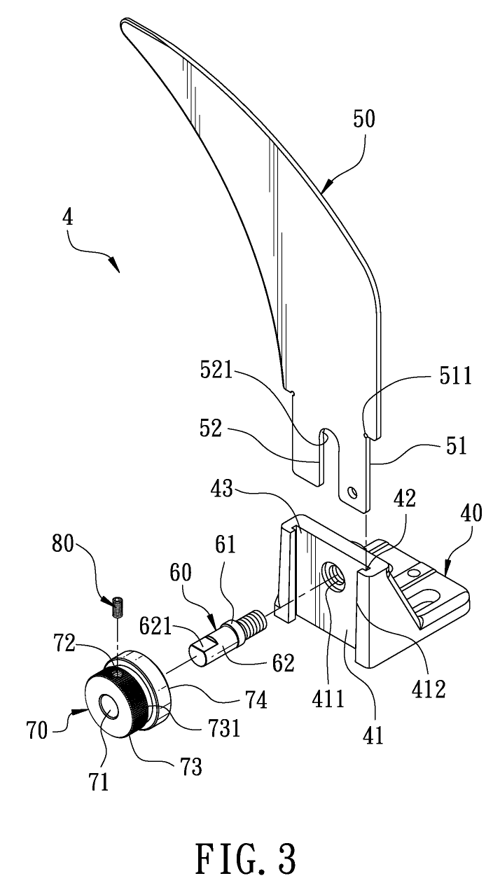

A first preferred embodiment of a combining device for the chopper set of a table sawing machine in the present invention, as shown in FIGS. 2 and 3, is assembled with a table sawing machine body 3, including a chopper set 4 that is composed of a fixing base 40, a chopper plate 50, an eccentric shaft 60, a rotary member 70 and a tightening bolt 80 as main components combined together.

The fixing base 40 to be secured at the inner side of the table sawing machine body 3 has one side formed with a vertical wall 41 bored with a threaded hole 411 at a location a little over its center. The vertical wall 41 has its opposite vertical sides respectively formed with a flange 412 having its corresponding inner side bored with a vertical position-limiting recess 42, with an open receiving space 43 formed between the two opposite vertical position-limiting recesses 42.

The chopper plate 50 has its lower end formed with a positioning member 51 to be slidably fitted in the two position-limiting recesses 42 and positioned in the receiving space 43 of the fixing base 40. The positioning member 51 has both sides of its upper edge, respectively corresponding to the two position-limiting recesses 42 and cut with a recessed corner 511 for preventing the chopper plate 50 from being stuck in the two position-limiting recesses 42 of the fixing base 40 when the chopper plate 50 is slidably fitted therein. The chopper plate 50 is further cut with a vertical long notch 52 at a location matching with the threaded hole 411 of the fixing base 40. The long notch 52 has its opposite sidewalls respectively provided with an engage recess 521.

The eccentric shaft 60 has its front side provided with threads to be pivotally screwed in the threaded hole 411 of the fixing base 40. The eccentric shaft 60 is annularly disposed with an eccentric press member 61 at a preset location and has its rear side formed with a turning member 62 having a rear end circumference cut with an axial fixing surface 621.

The rotary member 70 is bored with an axial insert hole 71 at a location matching with the eccentric shaft 60 for receiving therein the turning member 62 of the eccentric shaft 60. The rotary member 70 is bored in its rear annular wall with a vertical threaded hole 72 communicating with the axial insert hole 71. Further, the rotary member 70 has its rear side disposed with an actuating member 73 having its outer circumference formed with a serrated surface 731 to increase the friction coefficient for facilitating operation. Furthermore, the rotary member 70 has its inner end provided with a press surface 74 facing the eccentric shaft 60 for tightly pressing the copper plate 50 when the rotary member 70 is turned to drive the eccentric shaft 60 to rotate forward for fixing the chopper plate 50 in the position-limiting recesses 42 of the fixing base 40.

The tightening bolt 80 is screwed in the vertical threaded hole 72 of the rotary member 70, having its lower end tightly urging the axial fixing surface 621 of the eccentric shaft 60 for firmly combining the eccentric shaft 60 with the rotary member 70 together.

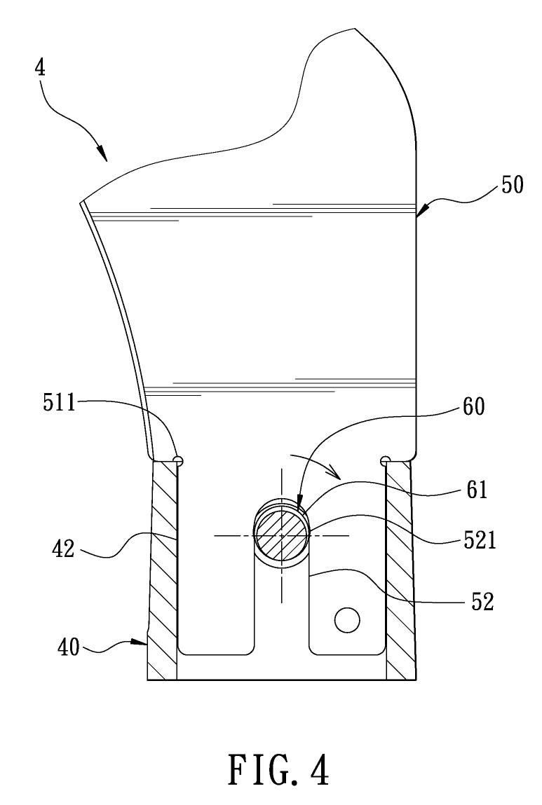

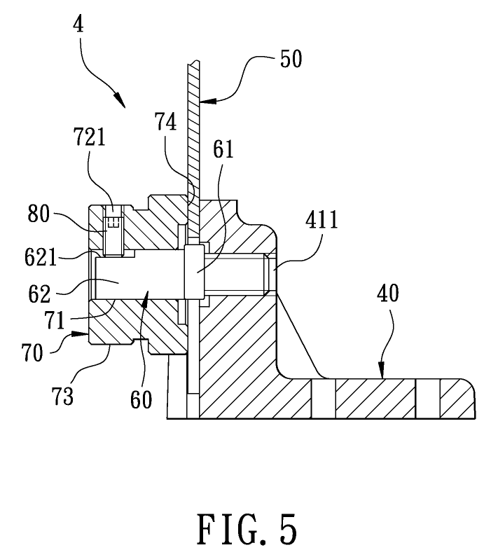

To assemble the chopper plate 50 on the fixing base 40, as shown in FIGS. 3, 4 and 5, firstly, the positioning member 51 of the chopper plate 50 is fitted in the opposite position-limiting recesses 42 of the fixing base 40, letting the chopper plate 50 clamped in the receiving space 43 between the fixing base 40 and the rotary member 70. Then, the actuating member 73 is turned clockwise to actuate the eccentric shaft 60 to rotate forward to have its press member 61 pushing against one sidewall of the long notch 52 of the chopper plate 50 and engaged in the engage recess 521 in the opposite walls of the long notch 52 for restrictedly fixing the chopper plate 50 between the fixing base 40 and the eccentric shaft 60. When the eccentric shaft 60 is driven to rotate clockwise, the press surface 74 of the rotary member 70 will synchronously be actuated to shift forward to press the chopper plate 50, letting the chopper plate 50 completely and firmly fixed on the fixing base 40, and at this time, the eccentric shaft 60 is stuck in the engage recess 521 of the chopper plate 50, thus strengthening the eccentric shaft 60 to firmly fix the chopper plate 50 on the fixing base 40.

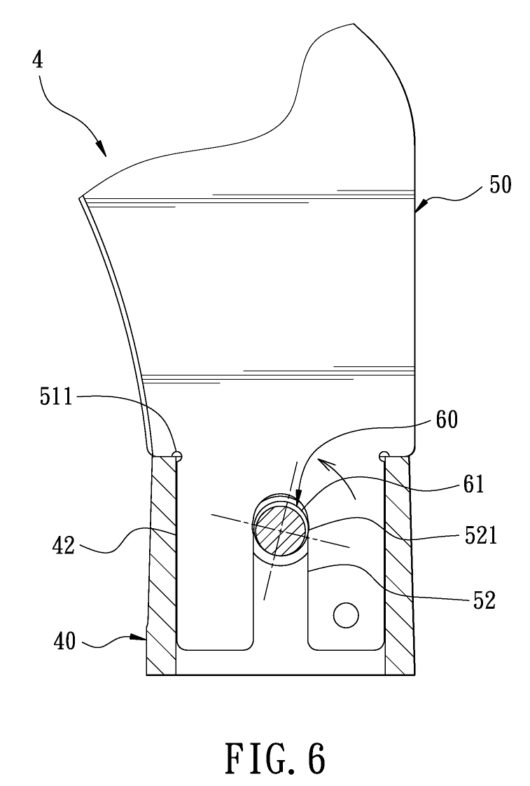

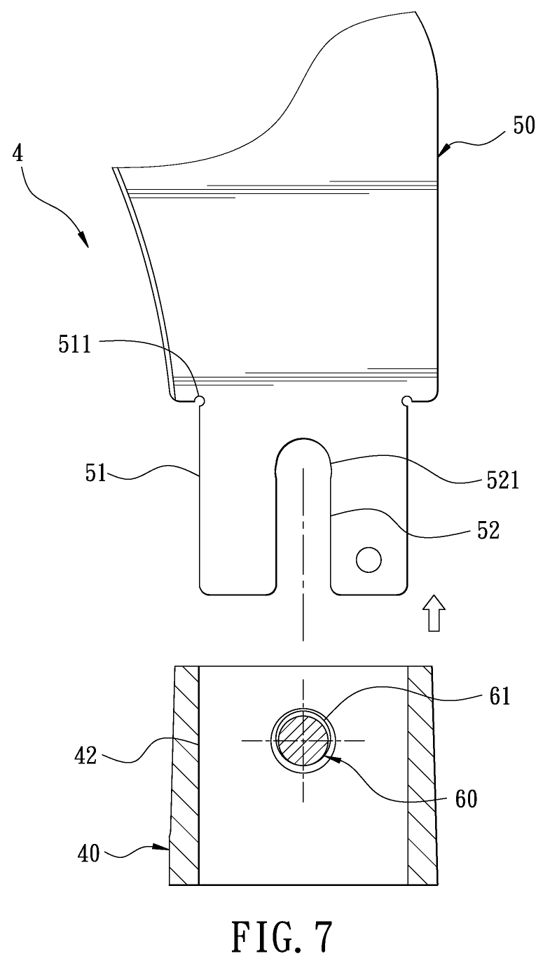

On the contrary, to disassemble the chopper plate 50 from the fixing base 40, as shown in FIGS. 3, 6 and 7, simply turn the actuating member 73 counterclockwise to disable the press member 61 of the eccentric shaft 60 to push against the sidewall of the long notch 52 of the chopper plate 50. At this time, an allowable gap is formed between the fixing base 40 and the press surface 74 of the rotary member 70; therefore, the chopper plate 50 can quickly be disassembled from the fixing base 40. Thus, by directly turning the actuating member 73 to drive the eccentric shaft 60 to rotate, a user can quickly assemble or disassemble the chopper plate 50 on or from the fixing base 40 without using any tool.

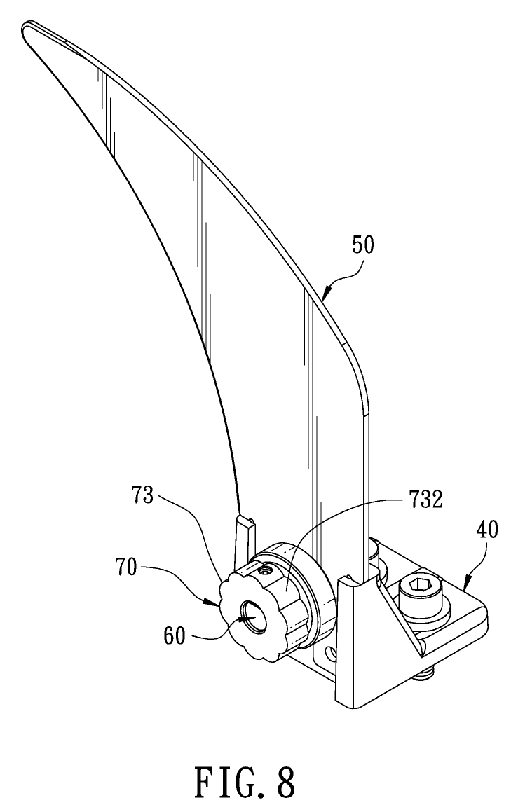

A second preferred embodiment of a combining device for the chopper set of a table sawing machine in the present invention, as shown in FIG. 8, has the same structure and function as those of the first preferred embodiment, except that the actuating member 73 of the rotary member 70 is made of a plum petal-shaped rotary button 732 so that a user can conveniently grasp and turn the rotary button 732 for driving the eccentric shaft 60 to rotate, convenient in use.

By so designing, the chopper plate can quickly and easily be assembled on or disassembled from the fixing base only by turning the rotary member to drive the eccentric shaft to rotate forward to press the chopper plate and firmly fix the chopper plate in the position-limiting recesses of the fixing base, needless to use any tool and saving time in assembling and disassembling of the chopper plate.

While the preferred embodiments of the invention have been described above, it will be recognized and understood that various modifications may be made therein and the appended claims are intended to cover all such modifications that may fall within the spirit and scope of the invention.

I claim:

1. A combining device for a chopper set of a table sawing machine comprising:
a fixing base secured at an inner side of a table sawing machine body, said fixing base having one side formed with a vertical wall bored with a threaded hole at a preset location, said vertical side wall of said fixing base having its opposite vertical sides respectively disposed with a projecting edge, said projecting edge having its corresponding inner sides respectively cut with a vertical position-limiting recess, with an open receiving space formed between two of said position-limiting recess;
a chopper plate having its lower end formed with a positioning member, said positioning member slidably fitted in said two position-limiting recesses of said fixing base, said positioning member cut with a vertical long notch at a location matching with said threaded hole of said fixing base; and
an eccentric shaft having its front side pivotally screwed in said threaded hole of said fixing base, said eccentric shaft axially disposed with an eccentric press member at a preset location, said eccentric shaft having its rear end provided with a turning member, said turning member turned to actuate said eccentric shaft to rotate, said eccentric shaft rotated forward to have said press member pushing against one sidewall of said long notch of said chopper plate for firmly fixing said chopper plate in said position-limiting recesses of said fixing base.

2. The combining device for the chopper set of a table sawing machine as claimed in claim 1, wherein said long notch of said chopper plate has its opposite sidewalls respectively disposed with an engage recess, said press member of said eccentric shaft engaged in said engage recess of said chopper plate when said press member is rotated to press one sidewall of said long notch.

3. The combining device for the chopper set of a table sawing machine as claimed in claim 1, wherein said turning member of said eccentric shaft is firmly fitted in a rotary member, said rotary member bored with an axial insert hole for said turning member of said eccentric shaft to be secured therein, said rotary member turned to drive said eccentric shaft to rotate.

4. The combining device for the chopper set of a table sawing machine as claimed in claim 3, wherein said rotary member has its front side provided with a press surface facing said eccentric shaft, said press surface of said rotary member able to tightly press said chopper plate when said rotary member is turned to drive said eccentric shaft to rotate forward for fixing said chopper plate.

5. the combining device for the chopper set of a table sawing machine as claimed in claim 3, wherein said rotary member has its rear circumference bored with a vertical threaded hole communicating with said axial insert hole, with a tightening bolt screwed in said vertical threaded hole, said turning member of said eccentric shaft having its rear end circumference cut with an axial fixing surface, said tightening bolt in said threaded hole having its lower end tightly resisting on said fixing surface of said eccentric shaft for firmly combining said eccentric shaft with said rotary member together.

6. The combining device for the chopper set of a table sawing machine as claimed in claim 3, wherein said rotary member has its rear side disposed with an actuating member for facilitating operation.

7. The combining device for the chopper set of a table sawing machine as claimed in claim 6, wherein said actuating member of said rotary member has its outer circumference formed with a serrated surface for increasing the friction coefficient.

8. The combining device for the chopper set of a table sawing machine as claimed in claim 6, wherein said actuating member of said rotary member is made of a rotary button.

9. The combining device for the chopper set of a table sawing machine as claimed in claim 1, wherein said positioning member of said chopper plate has its opposite sides respectively provided with a recessed corner at a location matching with said position-limiting recess of said fixing base, said opposite recessed corners of said positioning member preventing said chopper plate from being stuck in said position-limiting recesses when said chopper plate is slidably fitted therein.
